(19) United States
(12) Patent Application Publication
(10) Pub. No.: US 2007/0183695 A1
(43) Pub. Date: Aug. 9, 2007

(54) Fluid dynamic bearing system

(76) Inventor: Olaf Winterhalter, Epfendorf (DE)

Correspondence Address: NORMAN H. ZIVIN;Cooper & Dunham LLP, 1185 Avenue of the Americas, New York, NY, 10036, US

(21) Appl. No.: 11/701,131

(22) Filed: Feb. 1, 2007

(30) Foreign Application Priority Data
Feb. 6, 2006 (DE) 10 2006 005 604.3

(51) Int. Cl. F16C 32/06

(52) U.S. Cl. 384/100

(57) ABSTRACT

The invention relates to a fluid dynamic bearing system used particularly for a spindle motor, having a shaft, that is accommodated in a bearing bush and rotatably supported with respect to this bush, the bearing bush being tightly sealed at one end by a cover. According to the invention, the cover is made at least partly of plastics.

### BACKGROUND OF THE INVENTION

The invention relates to a fluid dynamic bearing system used particularly to rotatably support a spindle motor as employed, for example, to drive hard disk drives.

### PRIOR ART

Spindle motors substantially consist of a stator, a rotor and at least one bearing system arranged between these two parts. The electrically driven rotor is rotatably supported with respect to the stator by means of the bearing system. Fluid dynamic bearings are frequently employed as the bearing system.

DE 202 18 821 U1 reveals a typical fluid dynamic bearing system for spindle motors that comprises a bearing bush and a shaft which is disposed in an axial bore in the bearing bush. The shaft rotates freely in the bearing bush, the two parts together forming a radial bearing whose surfaces are spaced apart from each other by a thin, concentric bearing gap filled with a lubricant.

Axial displacement of the shaft along the rotational axis is prevented by appropriately designed fluid dynamic thrust bearings. These kinds of thrust bearings are frequently formed by the two end faces of a thrust plate arranged at one end of the shaft, each end face being associated with a corresponding end face of the bearing bush and an inner end face of a cover plate. The cover plate forms a counter bearing to the thrust plate and seals the entire bearing system from below.

The components of the bearing system are generally made of steel, aluminum or sintered metals and are connected to each other by pressing, welding or bonding. The material and assembly costs are thus relatively high.

### SUMMARY OF THE INVENTION

It is the object of the invention to provide a fluid dynamic bearing system for use in a spindle motor that can be built and assembled at significantly lower costs.

This object has been achieved according to the invention by the characteristics revealed in claim 1.

Preferred embodiments of the invention and other advantageous characteristics can be derived from the subordinate claims.

The fluid dynamic bearing system comprises a shaft that is accommodated in a bearing bush and rotatably supported with respect to the bearing bush. The bearing bush is tightly sealed at one end by a cover. According to the invention, provision is now made for the cover to be at least partly made from a plastic part which can be manufactured at very low cost and, as described below, is also very easy to assemble.

According to a first embodiment of the invention, the cover is given a disk-like shape, somewhat similar to a cover plate in a conventional bearing system. This cover fits snugly against an end face of the bearing bush and has fastening means for its detachable fastening to the bearing bush. At the same time, the cover can be disposed in a recess in the end face of the bearing bush, the fastening means preferably consisting of a locking mechanism that is provided at the circumference of the cover and by means of which the cover is fastened to the bearing bush or in the recess in the bearing bush respectively. However, the fastening means can also consist of a plurality of claws disposed at the circumference of the cover that engage into corresponding recesses in the outside circumference of the bearing bush and as a result hold the cover securely to the bearing bush.

In another embodiment of the invention the cover consists of a disk-shaped first component, which is preferably accommodated in a recess in the end face of the bearing bush, and a second component, which fits snugly against the first component and the end face of the bearing bush and has fastening means for its detachable fastening to the bearing bush. The fastening means in this embodiment are preferably designed as claws. The second component holds the first component in position and seals the opening in the bearing bush that is to be closed. The first component can take the shape of a conventional cover plate and can be made optionally of metal, ceramics or plastics. The second component and the fastening means are preferably made entirely of plastics. The first and the second component may also be made as a single piece or formed from two separate parts.

In another embodiment of the invention, the cover is preferably given the form of a cup and encloses at least the end face of the bearing bush and also has fastening means for its detachable fastening to the bearing bush. However, the cup-shaped cover may also enclose a large part of the bearing bush or fully accommodate the bearing bush. The fastening means of the cup-shaped cover preferably consist of a locking mechanism that is provided at the open rim of the cup and engages into corresponding recesses in the outside circumference of the bearing bush. Here, the mechanism can take the form of claws or a circumferential rim that locks into a recess in the bearing bush. For maximum cost savings, both the cover and the fastening means are preferably made entirely of plastics.

Like the cover plate in a conventional spindle bearing, the cover should hermetically seal the bearing as well. Depending on which of the above-described embodiments find application, additional sealing means, taking the form, for example, of an 0-ring, can be provided between the bearing bush and the cover.

The cover can additionally be designed as a part of an axial thrust bearing in that a surface of the cover facing the inside of the bearing system forms a fluid dynamic thrust bearing together with a surface of a thrust plate connected to the shaft. Such a fluid dynamic thrust bearing is marked in the conventional way by grooved patterns on at least one of the bearing surfaces, these grooved patterns preferably being formed on the surface of the cover.

The cover according to the invention goes to provide a low-cost part that not only tightly seals the bearing at one end but may also serve as a component of the bearing as well. The cover is connected to the bearing bush using simple fastening means, preferably lock-in fasteners. In addition, adhesives can also be used for connecting purposes. This does away with the relatively costly method used to date of welding the cover (cover plate) to the bearing bush.

A cup-shaped cover that fully encloses the bearing bush has the further advantage of being used for resonance damping since the bearing bush is held by this cover in the baseplate of the spindle motor. The damping effect goes to reduce the running noise of the spindle motor.

### BRIEF DESCRIPTION OF THE DRAWINGS

FIG. 1 shows a cross-section through a spindle motor showing an example of an embodiment of the bearing system according to the invention.

FIG. 2 shows a view from above of the cover according to the invention of the bearing system.

FIG. 3 shows a cross-section through the cover according to the invention of the bearing system.

FIG. 4 shows an enlarged view of the fastening means taking the form of claws.

FIG. 5 shows a perspective view of the cover of the bearing system.

FIG. 6 shows the bearing system according to the invention in partial section.

FIG. 7 shows a second embodiment of the bearing system according to the invention.

FIG. 8 shows a third embodiment of the bearing system according to the invention.

FIG. 9 shows a fourth embodiment of the bearing system according to the invention having a cup-shaped cover.

FIG. 10 shows a perspective view of a cup-shaped cover having claws.

FIG. 11 shows a perspective cross-section through a cup-shaped cover having a lock-in collar.

### DESCRIPTION OF PREFERRED EMBODIMENTS OF THE INVENTION

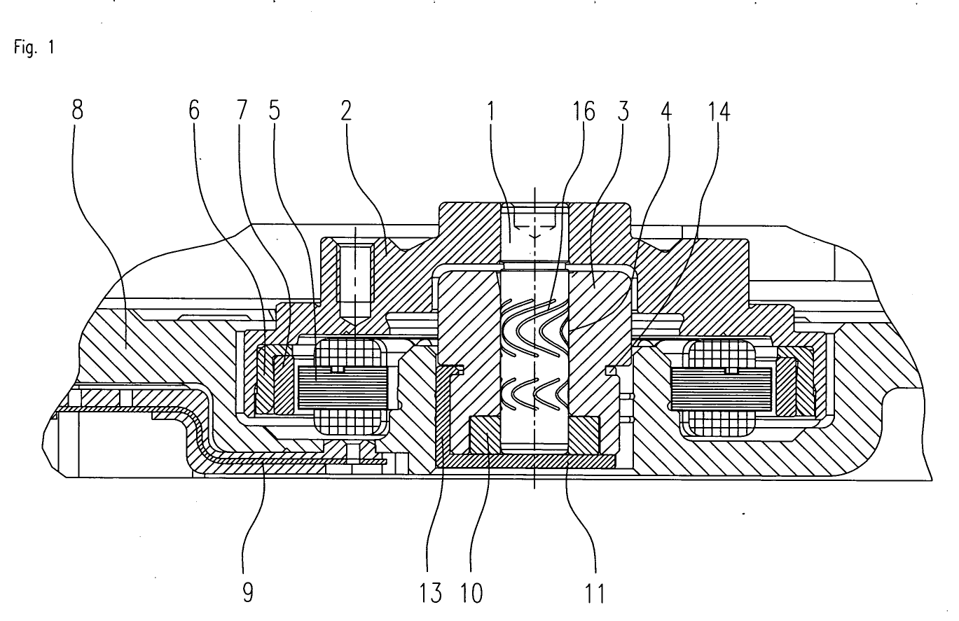

The spindle motor according to FIG. 1, which can be used, for example, to drive a hard disk drive, comprises a stationary baseplate 8 on which a stator arrangement 5, made up of a stator core and windings, is arranged. A bearing bush 3 is held in a recess in the baseplate and has a cylindrical axial bore in which a shaft 1 is rotatably accommodated. The free end of the shaft 1 carries a hub 2 on which one or more storage disks (not illustrated) of the hard disk drive can be disposed and fixed. An annual permanent magnet 7 enclosed by a yoke 6 and having a plurality of pole pairs is disposed at the lower inside edge of the hub 2, an alternating electric field being applied to the pole pairs via a stator arrangement 5 spaced apart from them by means of an air gap, so that the hub 2 together with the shaft 1 is put into rotation. Power is supplied to the stator windings by means, for example, of an electric connector lead 9. The shaft 1, together with the bearing bush 3 and a thrust plate 10 disposed at one end of the shaft 1, forms a fluid dynamic bearing system having radial bearing and axial bearing surfaces that are separated from each other by an air gap 4. The construction and function of these kinds of fluid dynamic bearing systems is known to a person skilled in the art and shall not be described in more detail here. The bearing arrangement is sealed from below, i.e. in the region of the thrust plate 10, by a cover 11.

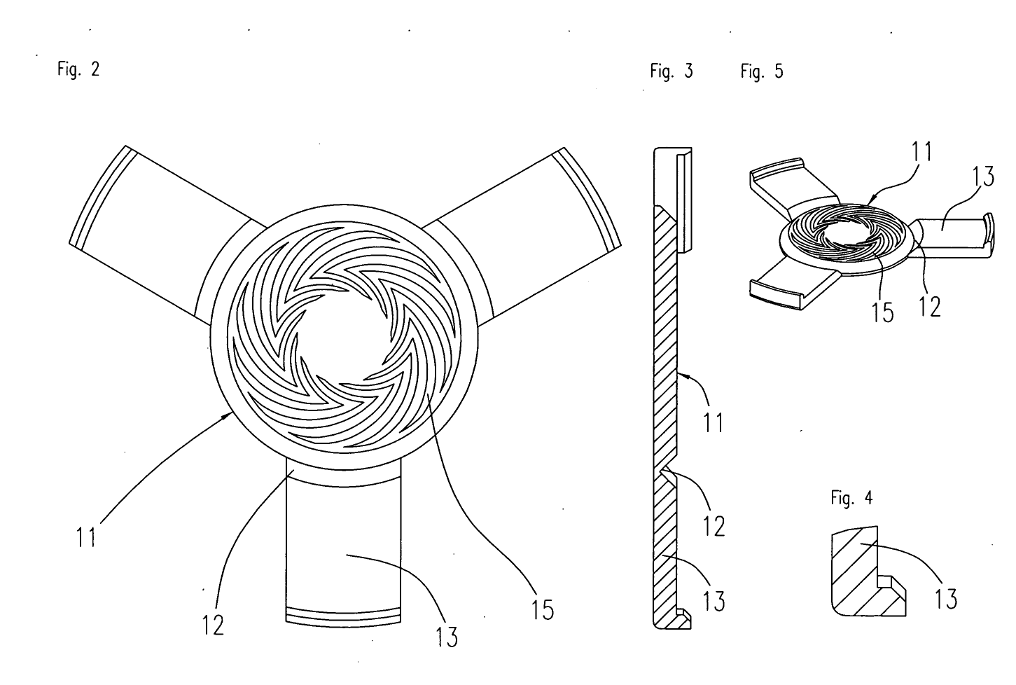

FIGS. 2 to 5 show one possible embodiment of the cover 11 that preferably comprises an approximately disk-shaped region on whose outside circumference several claws 13 are arranged. The claws 13 are joined to the central part of the cover 11 by an integrated hinge 12. The cover 11 is made entirely from an injection-molded plastic piece and is thus cheap and easy to manufacture.

The cover 11 is mounted to the end face of the bearing bush 3 in that the cover 11 is placed on the end face of the bearing bush 3 and the claws bent at a right angle using the hinges, special recesses 14 being provided at the outside circumference of the bearing bush 3 into which the hook-shaped projections of the claws 13 engage. This allows the cover 11 to be securely yet detachably fastened to the bearing bush 3.

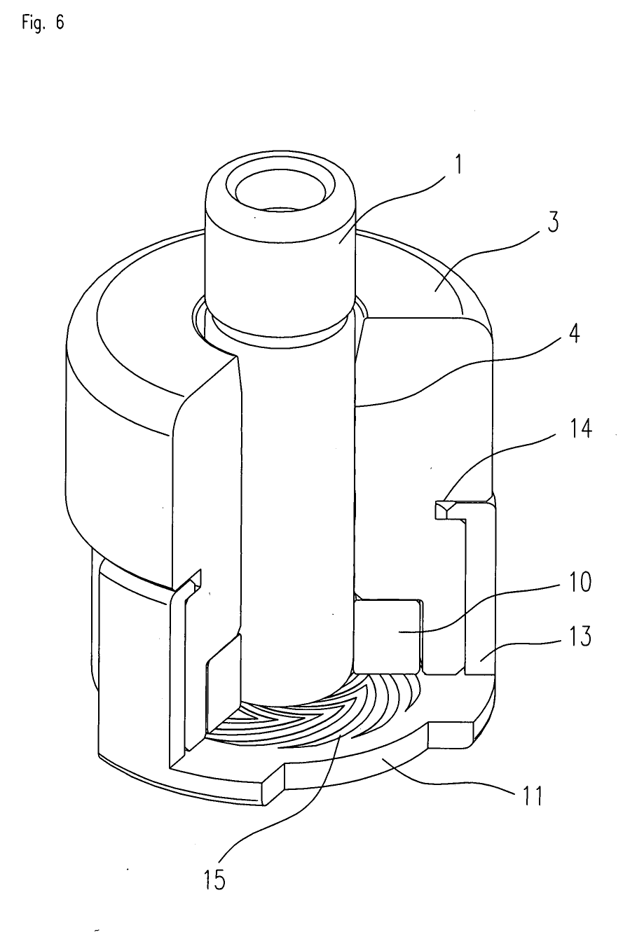

FIG. 6 shows a perspective view of the cover 11 engaged into the bearing bush 3.

As can particularly be seen in FIGS. 2 and 5, the surface of the cover 11 facing the thrust plate 10 can be provided with a grooved pattern 15 that, together with the opposing surface of the thrust plate 10, defines an axial thrust bearing. As soon as the thrust plate 10 together with the shaft 1 is put into rotation, the grooved pattern 15 generates hydrodynamic pressure in the bearing fluid in the air gap between the thrust plate 10 and the cover 11. The grooved pattern 15 can also be easily and cheaply applied during the manufacture of the cover 11. The radial bearing regions between the shaft 1 and the bearing bush 3 are also marked by corresponding grooved patterns 16.

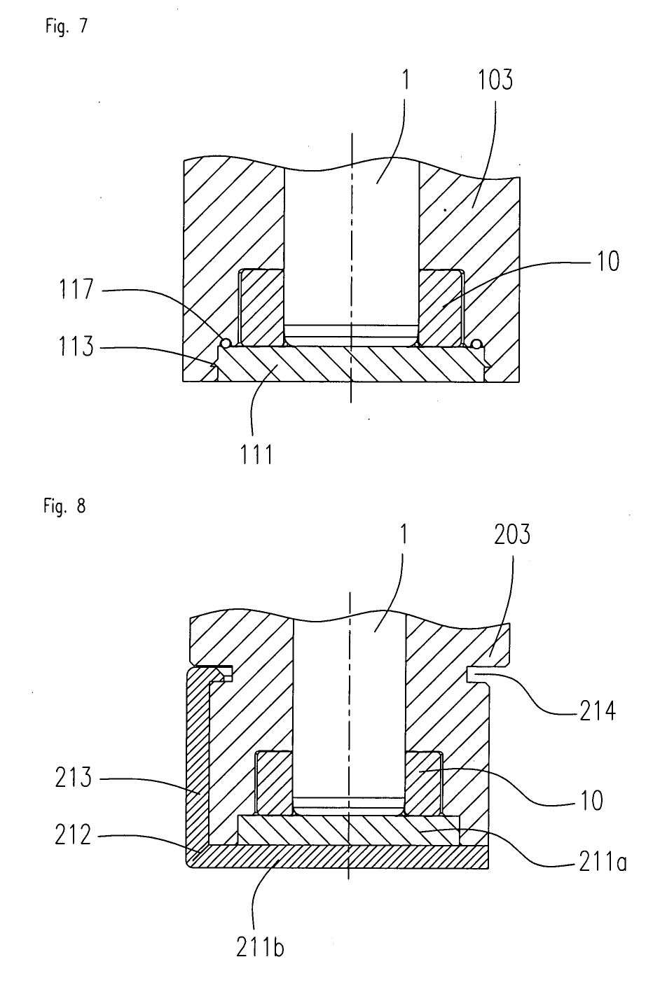

FIG. 7 shows a second embodiment of the fluid dynamic bearing system whose construction resembles the bearing system according to FIG. 1. In this embodiment, the cover 111 is given the form of a disk-shaped cover plate that seals the bearing in the region of the thrust plate 10. The cover 111 is seated in a recess in the end face of the bearing bush 103 and has a circular lock-in collar about its outside circumference 113 which engages into a catch recess in the bearing bush 103 when the cover 111 is inserted into the recess in the bearing bush 103. To ensure a tight connection between the bearing bush 103 and the cover 111 additional sealing means, such as an 0-ring 117, can be provided. According to the invention, the cover 111 is made of plastics.

FIG. 8 shows a third embodiment of the bearing system according to the invention which basically corresponds to the embodiment of FIG. 1. However, the cover 211 is formed in two parts and consists of a first component 211a that is given the form of a disk-shaped cover plate and seals the bearing from below in the region of the thrust plate 10. This cover-plate 211a is held in the recess in the bearing bush 203 by a cover 211b made of plastics and is held by means of claws 213 that engage into corresponding recesses 214 in the outside circumference of the bearing bush 203. Both the first component 211a as well as the second component 211b can be made of plastics, although the first component 211a may also be optionally made of metal. The components 211a and 211b can be made up of two separate parts or they could also be designed as a single integrated part.

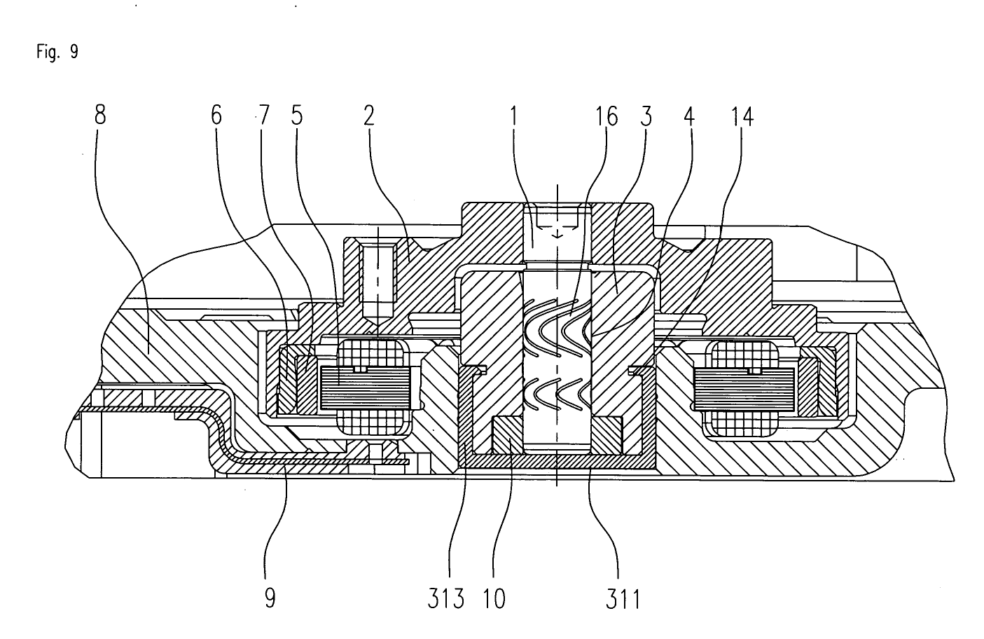

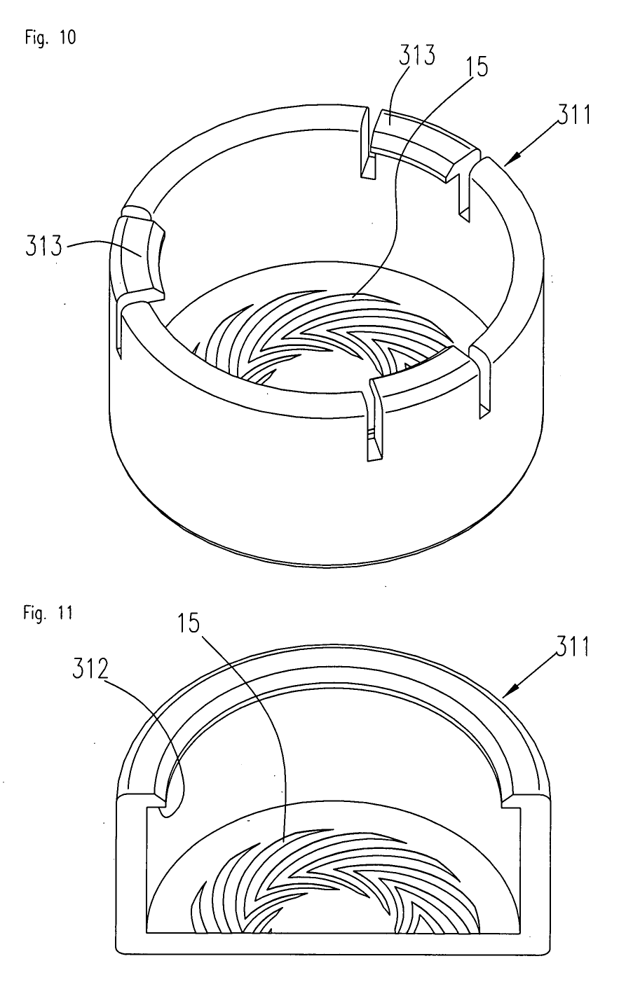

FIGS. 9 to 11 show another embodiment of the bearing system of the invention for a spindle motor according to FIG. 1. In this embodiment, the cover 311 is given a cup-shaped form and encloses the end face and a part of the bearing bush 3. However, the cover could also enclose a large part of the bearing bush 3 or accommodate the bearing bush 3 fully. For its detachable fastening to the bearing bush 3, the cup-shaped cover 311 has fastening means that preferably consists of a locking mechanism that is provided at the open rim of the cup 311 and engages into corresponding recesses 14 in the outside circumference of the bearing bush 3. The locking mechanism can take the form of claws 313 (FIG. 10) or a lock-in collar 312 (FIG. 11) running about the inside circumference of the cup that engage into the recesses 14 in the bearing bush 3. For maximum cost savings, both the cover as well as the fastening means are preferably made entirely of plastics.

Identification Reference List

1 Shaft
2 Hub
3 Bearing bush
4 Air gap
5 Stator arrangement
6 Yoke
7 Magnet
8 Baseplate
9 Connector lead
10 Thrust plate
11 Cover
12 Hinge
13 Claws
14 Recess (bearing bush)
15 Grooved pattern (cover)
16 Grooved pattern (shaft)
103 Bearing bush
111 Cover
113 Lock-in collar
117 O-ring
203 Bearing bush
211a Cover plate
211b Cover
212 Hinge
213 Claws
214 Recess (bearing bush)
311 Cover (cup)
312 Lock-in collar
313 Claws

1. A fluid dynamic bearing system used particularly for a spindle motor, having a shaft (1) that is accommodated in a bearing bush (3; 103; 203) and rotatably supported with respect to this bush, the bearing bush being tightly sealed at one end by a cover(11; 111; 211; 311), characterized in that the cover (11; 111; 211; 311 ) is made at least partly of plastics.

2. A fluid dynamic bearing system according to claim 1, characterized in that the cover (11; 111; 211) is given a substantially disk-like shape, fits snugly against one end face of the bearing bush and has fastening means (13; 113; 213) for its detachable fastening to the bearing bush.

3. A fluid dynamic bearing system according to claim 2, characterized in that the fastening means (13; 113; 213) have a locking mechanism that is provided at the circumference of the cover and by means of which the cover is fastened to the bearing bush.

4. A fluid dynamic bearing system according to claim 1, characterized in that the cover is made up of a disk-shaped first component (211a), which is accommodated in a recess in the end face of the bearing bush (203), and a second component (211b), which fits snugly against the first component (211a) and the end face of the bearing bush (203) and has fastening means (213) for its detachable fastening to the bearing bush.

5. A fluid dynamic bearing system according to claim 4, characterized in that the first component (211a) is optionally made of metal, ceramics or plastics and the second component (211b) together with the fastening means are made entirely of plastics.

6. A fluid dynamic bearing system according to claim 2, characterized in that the fastening means (13; 213) is made up of a plurality of claws that are provided at the outside circumference of the cover (11; 211) and engage into corresponding recesses (14; 214) in the outside circumference of the bearing bush.

7. A fluid dynamic bearing system according to claim 1, characterized in that the cover (311) is given a cup-like shape, encloses the end face of the bearing bush and has fastening means (312; 313) for its detachable fastening to the bearing bush (3).

8. A fluid dynamic bearing system according to claim 7, characterized in that the fastening means have a locking mechanism (312; 313) that is provided at the open rim of the cup-shaped cover and engages into corresponding recesses (14) in the outside circumference of the bearing bush (3).

9. A fluid dynamic bearing system according to claim 2, characterized in that the cover (1 1; 1 1 1; 21 1; 311) and the fastening means (13; 113; 213; 312; 313) are made entirely of plastics.

10. A fluid dynamic bearing system according to claim 1, characterized in that additional sealing means (117) are provided between the bearing bush and the cover.

11. A fluid dynamic bearing system according to claim 1, characterized in that a surface of the cover (11; 11 1; 21 1; 311) facing the inside of the bearing system together with a surface of a thrust plate (10) connected to the shaft (1) form a fluid dynamic thrust bearing.

12. A fluid dynamic bearing system according to claim 1, characterized in that the surface of the cover (11; 111; 21 1; 31 1) has a grooved pattern (15).
